(19) United States
(12) Patent Application Publication
(10) Pub. No.: US 2014/0034066 A1
(43) Pub. Date: Feb. 6, 2014

(54) Customizable Mouthpiece for Scuba-Divers

(71) Applicant: Randall Moles, Racine, WI (US)

(72) Inventor: Randall Moles, Racine, WI (US)

(21) Appl. No.: 13/566,759

(22) Filed: Aug. 3, 2012

(51) Int. Cl. A62B 9/06; A61C 5/14

(52) U.S. Cl. 128/862

(57) ABSTRACT

A customizable scuba-diving mouthpiece for gripping with a diver's teeth, the mouthpiece including including a front member forming a horizontal passageway and a U-shaped back member with a pair of leg portions each including a thermoformable custom-moldable bite portion which in some embodiments is substantially X-shaped in cross-section along the bite-line. Upper-inner and lower-inner wall-portions of each leg portion may terminate rearwardly beside the diver's premolars and forward of the diver's first molar, thereby reducing gagging effect. The passageway may be defined by tapered inner sidewall portions defining the greatest between-sidewall-portions cross-dimension at the leg portions. A bite-limiter may be inserted into the passageway and includes a bite-limiting portion positioned for engagement with the diver's incisors to control the degree of bite and depth of tooth impressions, the bite-limiting portion having a thickness no greater than one third of a passageway vertical dimension.

### FIELD OF THE INVENTION

This invention is related generally to scuba-diving mouthpieces and, more particularly, to mouthpieces of the type customizable for individual divers.

### BACKGROUND OF THE INVENTION

Scuba-diving mouthpieces of various kinds have been known and used for many years. The great majority of such mouthpieces are not customizable for individual divers, but some customizable scuba-diving mouthpieces have been known or used. Examples of customized or customizable scuba-diving mouthpieces are those shown in U.S. Pat. No. 3,107,667 (Moore), U.S. Pat. No. 3,844,281 (Shamlian), U.S. Pat. No. 3,929,548 (Shamlian), U.S. Pat. No. 4,136,689 (Shamlian), U.S. Pat. No. 5,031,611 (Moles), U.S. Pat. No. 5,305,741 (Moles) and U.S. Pat. No. 5,865,170 (Moles).

Despite advances in recent years, there are various problems and shortcomings with scuba-diving mouthpieces of the prior art, including with those of the above-listed patents. One fairly common problem relates to mouth fatigue experienced by scuba divers during use including those of the above labeled patents.

The Moles patents identified above brought about significant improvements that helped to overcome many of the problems related to mouth fatigue and the production of a customized fit. Despite such significant improvements, problems still remain particularly in regard to obtaining a tight seal between the mouthpiece and the diver's gums and the gag reflex that results when an object is inserted in the rear portions of the mouth.

Regarding the formation of a tight seal, mouthpieces of the prior art are unable to form as strong a seal between the diver's gums and the mouthpiece itself as may be desired. Known mouthpieces are shaped such that the top and bottom of their front portion are substantially aligned with the diver's gum line. Such alignment prevents the formation of a strong seal between the diver's gums and the mouthpiece thereby allowing for water to seep into the diver's mouth. A mouthpiece that would more comfortably allow for the formation of a seal between itself and the diver's gums would be a significant improvement in the art.

Another major problem associated with scuba-diving mouthpieces is the gag-reflex that is activated by the extension of the bite portion further back into the diver's mouth. While moving the contact location between the diver's teeth and the mouthpiece further back in the mouth decreases jaw fatigue, such extension tends to increase the likelihood that the diver will “gag” on rear portions of the mouthpiece. There is a need for improvements which will serve to decreasing jaw fatigue while reducing the propensity for gag-reflexes.

Finally, the outer surfaces of known scuba-diving mouthpieces are such that the diver's lips and cheeks are forced to stretch in order to completely surround the device. An improvement in the shape of the outer surface such that it would allow the diver's mouth to close more naturally around the mouthpiece would be an important improvement in the art.

Mouthpieces are typically held in place by means of the diver's bite on retaining members which project inwardly from a lip-engaging portion to positions between the upper and lower teeth. This not only places significant pressures on small portions of the diver's teeth, that is, the portions engaging the retaining members, but the constant muscle pressure needed for secure retention of such mouthpieces can cause significant muscle strain and aching.

The problems of jaw fatigue and joint strain during long use are accompanied by a related problem—a tendency toward an inability by the diver to easily maintain the mouthpiece in the proper orientation, particularly when pressures are applied to the mouthpiece from outside the diver's mouth. Unwanted pressures on the mouthpiece grip come from water currents (relative to the diver), contacts made with diving apparatus, and a variety of other causes. It is essential, of course, that the diver's mouthpiece, which is the sole source of air, remain in place. Thus, the concern about pressure interfering with the grip of the diver on his or her mouthpiece is more than a casual concern.

Some problems with current scuba-diver mouthpieces can be understood better by reference to the mouth, the jaw, and the teeth of a typical person. The jawbone is a lengthy angled member which pivots with respect to the skull and about the jaw joint well back from the mouth. Such joint is typically positioned considerably above the level of the teeth and well behind the position of the teeth. From such joint, the jaw has a generally downwardly and slightly forwardly extending portion which extends generally to a position rearwardly spaced from the teeth, and a more forwardly, but still downwardly, extending portion which carries the teeth of the lower jaw and extends forwardly beneath the upper jaw. The angle between the two positions of the lower jaw is referred to herein as the “jaw angle.”

Opening and closing muscle tissue masses are secured to the jaw at positions forward of the jaw joint, but well rearward of the teeth. The muscles secured to the lower jaw create a lever arm which extends from the jaw joint all the way to the point of contact pressure of the lower jaw with the upper jaw or with whatever is being bitten.

When using a typical diving mouthpiece, or a customized diving mouthpiece such as those shown in the aforementioned Shamlian patents, the lever arm of the lower jaw extends from the jaw joint all the way forward to the position of the eye teeth where the mouthpieces are gripped between the diver's teeth.

Two separate problems are created when the mouthpiece contact occurs in this manner at such forward position in the mouth: First, since the distance from the center of muscle effort is long, a significant increase in muscle force is necessary to stabilize and retain the mouthpiece. This is what causes the muscles to quickly fatigue and often to become painful, which leads to jaw aches and headaches. A second and related problem of such long lever arm is created when standard mouthpieces, or customized mouthpieces of the Shamlian type are used, in that there is a severe increase in pressure within the jaw joint, well back in the head.

If the contact location is extended to the back of the mouth, the lever arm is shortened and advantages are achieved, including a reduction in the muscle force necessary to hold the mouthpiece and a reduction in the corresponding jaw pressure. Lengthening the mouthpiece retention piece to allow contact at a more rearward position in the mouth creates a shorter, and thus more favorable, lever arm. This resists torque from movement of the diver's regulator. That is, a better grip can be maintained with less exertion.

However, extension of the posterior bite pieces has been difficult or unworkable in the prior art due to variability in the jaw alignment of different people. Only a completely customized bite portion would allow for this. The variability in the angle between the teeth of the upper and lower jaws is a major problem. Such variability is caused by variations in the aforementioned lower jaw angle and also by the angle of the upper jaw with respect to the lower jaw. The upper jaw may be tipped up or down in the front or back.

Furthermore, the extension of the bite pieces result in an increase of the gag-reflex. Therefore, in order to take advantage of the reduction in jaw fatigue that results from a reduction in the length of the lever arm, alterations must be made to the bite portions in order to reduce the possibility of gagging.

While there have been a number of efforts to make improved customizable scuba-diving mouthpieces, there has remained a clear need for significant improvements in the field of customizable scuba-diving mouthpieces.

### SUMMARY OF THE INVENTION

This invention, which will be described in detail below, is an improvement in a customizable scuba-diving mouthpiece for gripping with a diver's teeth. The mouthpiece is of the type including front and back members. The front member extends from a proximal in-mouth end to a distal outside end and forms a horizontal passageway between the proximal and distal ends. The back member is U-shaped and has a middle portion and a pair of leg portions. The middle portion is secured to the front-member proximal end. The pair of leg portions each extend from the middle portion rearwardly for positioning along and between the diver's teeth and terminate at the rear of the diver's mouth. Each leg portion includes a thermoformable custom-moldable bite portion.

In the inventive customizable scuba-diving mouthpiece, each bite portion is preferably formed by upper-outer and lower-outer wall-portions and upper-inner and lower-inner wall-portions. All wall-portions are adjoined at a common bite line. Each wall-portion extends outwardly from the bite line such that each leg portion has a substantially X-shaped cross-section across the bite line.

The bite line is preferably along a minimal horizontal shelf between outer and inner wall-portions. It is preferred that the bite portion be substantially free of the horizontal shelf. The corresponding outer and inner wall-portions preferably form substantially sharp-angled upper and lower concavities along the bite line.

Such configuration with minimal horizontal surfaces and initial positioning of the unmolded side surfaces along the bite line in close proximity to the diver's teeth facilitates better side engagement for easier, more precise molding of the bite portions resulting in better holding of the mouthpiece during use. The initial proximity of the unmolded side surfaces to the diver's teeth further decreases lateral expansion of the bite surfaces that takes place when the mouthpiece is molded to the diver's teeth.

The upper-outer and lower-outer wall-portions of each leg portion define an outer-surface concavity along the bite portion of the respective leg portion. Such concavity further compensates for the lateral expansion of the bite surfaces.

In preferred embodiments, the upper-inner and lower-inner wall-portions of each leg portion each originate laterally to the respective one of the diver's canines. It is highly preferred that the upper-inner and lower-inner wall-portions each terminate rearwardly beside the diver's premolars and forward of the diver's first molar. Such shortened dimension of the inner wall-portions facilitates reduction of the gagging effect because there is less of the inner wall-portions surfaces reacting against the rear lateral surfaces of the diver's tongue. Such lateral portions of the tongue (sometimes referred to by dental professionals as “lateral aspects”) are primarily responsible for the gag reflex. The more forward termination of the inner wall portions also allows lateral air flow which reduces turbulence and improves air passage around closed teeth which otherwise block airflow.

The passageway between the proximal and distal ends of the front member is preferably defined by tapered inner sidewall portions which define the greatest between-sidewall-portions cross-dimension at the leg portions, thereby facilitating air-flow for the diver's breathing under water. In some embodiments, each sidewall portion extends from at least a middle of the passageway to the respective one of the leg portions. In other words, the passageway has the widest horizontal cross-dimension at the proximal in-mouth end adjacent the leg portions. The passageway cross-dimension gradually decreases toward the middle of the passageway. Such in-mouth widening of the passageway further facilitates lateral air flow, thereby facilitating air-flow for the diver's breathing under water despite the presence of the teeth which substantially block the air-flow.

Another aspect of the present invention is a method for customizing a scuba-diving mouthpiece for gripping with a diver's teeth. In the inventive method, a bite-limiter is provided. The bite-limiter is of a resilient material that provides soft minimal biting by the diver's incisors while maintaining its integrity in thermoforming temperatures and retaining its shape during the thermoforming process. An example of such material may be a vinyl that becomes moldable at temperatures significantly higher that the boiling temperature of water. Of course, any other suitable material may be used to provide soft texture for comfortable biting. The bite-limiter is positioned between the leg portions at the proximal end of the front member such that the diver's incisors engage the bite-limiter during molding process to control the degree of bite and depth of tooth impressions. The bite-limiter has an upper surface and a lower surface which are spaced from one another by a distance corresponding to an appropriate degree of openness of the mouth for scuba diving.

For molding, the leg portions are heated until the respective bite portions become moldable. The heating is by submerging the leg portions in water at near-boiling temperature for a time period sufficient for the bite portions to become moldable. The heated unmolded mouthpiece is placed in the mouth of the diver with the bite portions positioned between the diver's teeth. The mouthpiece is molded by the diver biting the bite portions until the upper and lower incisors engage the bite-limiter to make tooth impressions in the bite portions. Then the mouthpiece is removed from the diver's mouth and set with the molded bite portions which have deep impressions of the diver's teeth and gums. Such custom-molded mouthpiece has leg portions that closely conform to the diver's teeth and gums for comfortable use and improved breathing under water while diving.

It is preferred that the bite-limiter be configured to extend through and beyond the front-member passageway. The positioning step preferably includes the step of inserting the bite-limiter into the passageway such that the bite-limiter is positioned for engagement with the diver's incisors.

The bite-limiter preferably includes an exterior handle portion configured for holding by person's fingers to handle the mouthpiece during the thermoforming process, an insert portion which extends from the handle portion for positioning within the passageway and a bite-limiting portion which extends from the insert portion for positioning between the leg portions of the mouthpiece for engagement with the diver's incisors to control the degree of bite and depth of tooth impressions. It is preferred that the bite-limiting portion have a thickness no greater than one third of a passageway vertical dimension. The bite-limiting portion is preferably no more than three millimeters thick. The bite-limiting portion is preferably no less than about one millimeter thick.

In some embodiments, the bite-limiting portion is vertically offset from the middle of the insert portion to accommodate diver's teeth overlap. In other words, the bite-limiting portion is offset above or below the middle of the bite-limiter. This is a modification that helps accommodate the molding process for someone who's front teeth overlap a lot or very little. By flipping over the plug, the bite-limiting portion is placed higher or lower relative to the center of the biting area.

The bite-limiting portion is preferably of a resilient material that provides soft minimal biting by the diver's incisors while maintaining its integrity in thermoforming temperatures and retaining its shape during the thermoforming of the mouthpiece.

The bite-limiter may have an integrally-formed single piece including the exterior handle portion and the insert portion with the bite-limiting portion secured with respect thereto. In some embodiments, the bite-limiter is an integrally-formed single piece including the exterior handle portion, the insert portion and the bite-limiting portion.

As used herein, the term “X-shaped”—means substantially free of any horizontal shelf portion between teeth-adjacent surfaces of the outer and inner wall-portions. The biting portions of the customizeable mouthpiece of the present invention may have a minimal space between teeth-adjacent surfaces of the outer and inner wall-portions. Such space is preferably no more than a small fraction of the width of the molars. For example, the teeth-adjacent surfaces may be spaced for less than ¼ of the molar which provides a greater lateral formation engagement with molars and reduces horizontal displacement of the mouthpiece material. In another example, the teeth-adjacent surfaces may be merging together by forming a trough with a curved bottom along the bite line.

This is in contrast to prior customizeable mouthpieces for scuba-divers which have biting portions with a horizontal shelf of at least about ¼ inch and about 4 mm thick. In such prior mouthpieces, during the customizing process the diver sinks his/her teeth into the thickness of the shelf pushing the material of the shelf sideways toward the diver's cheeks and tongue. Because of the substantial width of the biting shelf, sides of the diver's teeth or his/her gums may not come in sufficient contact with the mouthpiece material resulting in lose fit of the mouthpiece which would require additional diver's effort to hold the mouthpiece under water and reduce tightness of the mouth seal resulting in water seeping into the diver's mouth affecting diver's underwater breathing.

### BRIEF DESCRIPTION OF THE DRAWINGS

FIG. 1 is a perspective view of an embodiment of the inventive customizable scuba-diving mouthpiece, illustrated translucently to show with the mouthpiece a bite-limiter according to the present invention.

FIG. 2 is a rear elevation of the mouthpiece of FIG. 1.

FIG. 3 is a rear perspective view of the mouthpiece of FIG. 1 without the bite-limiter and showing the passageway.

FIG. 4 is a side perspective view of the mouthpiece of FIG. 3.

FIG. 5 is a top elevation of the mouthpiece of FIG. 3.

FIG. 6 is a top elevation of the mouthpiece and the bite-limiter as illustrated in FIG. 1.

FIG. 7 is a side elevation of the mouthpiece of FIG. 3.

FIG. 8 is a side elevation of the mouthpiece and the bite-limiter as illustrated in FIG. 1.

FIG. 9 is a front-side perspective view of the mouthpiece of FIG. 3.

FIG. 10 is a front-top perspective view of the mouthpiece of FIG. 3.

FIG. 11 is an enlarged section across the bite line, as indicated by section 11-11 in FIG. 5, shown without background,

FIG. 12 is an enlarged lengthwise section, as indicated by section 12-12 in FIG. 5, showing a configuration of the passageway.

FIG. 13 is a rear elevation of an embodiment of the inventive mouthpiece with the bite-limiter having an offset bite-limiting portion.

FIG. 14 is a side elevation of an embodiment of the mouthpiece with the bite-limiter having an offset bite-limiting portion.

FIG. 15 is a posterior view of person's teeth taken from inside mouth.

FIG. 16 is fragment plan view of a person's teeth.

### DETAILED DESCRIPTION OF PREFERRED EMBODIMENTS

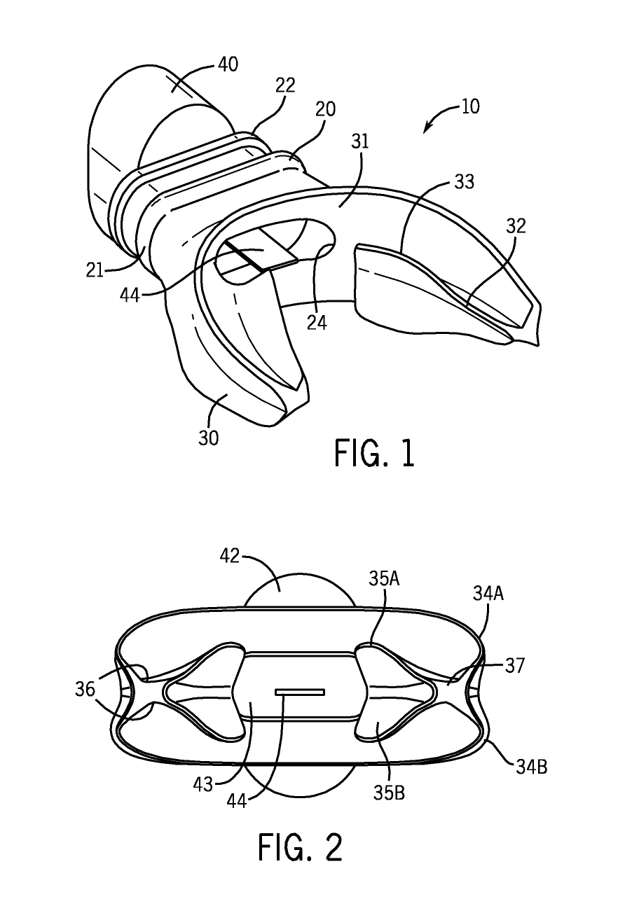

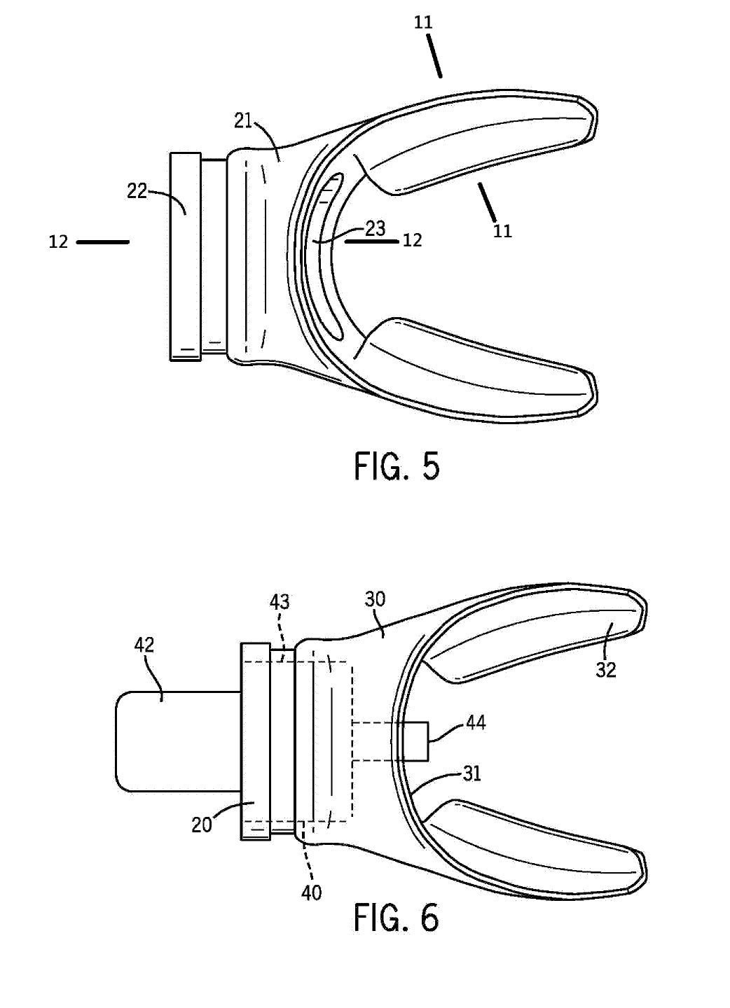

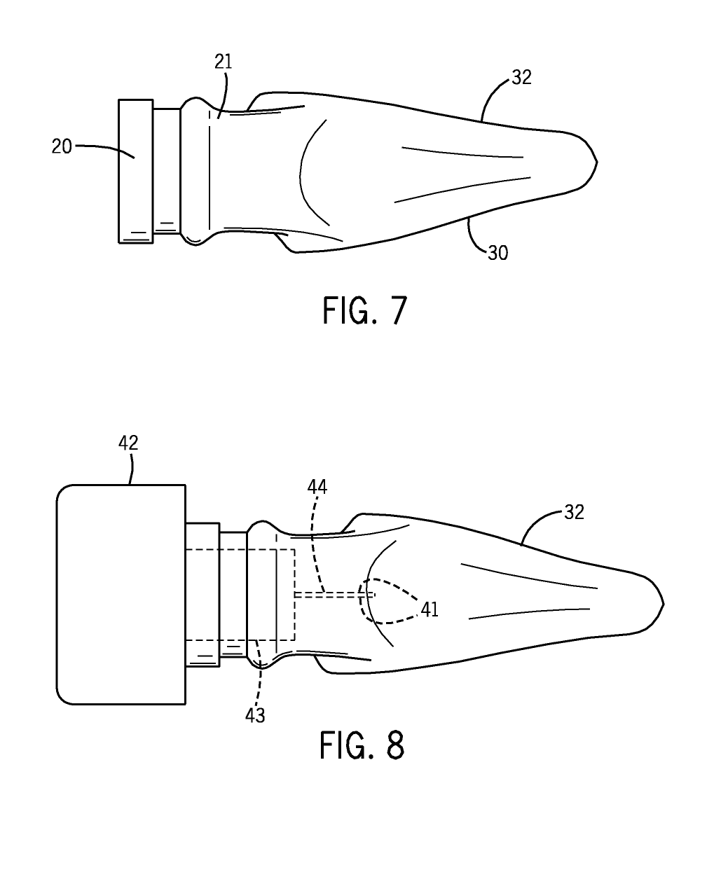

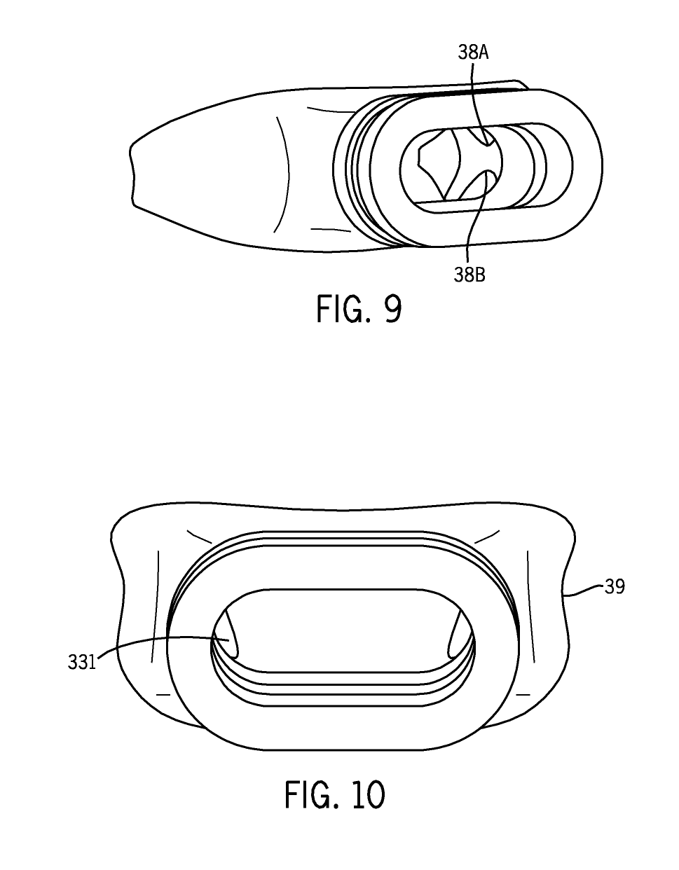

FIGS. 1-14 illustrate exemplary embodiments of a customizable scuba-diving mouthpiece 10 for gripping with a diver's teeth. Mouthpiece 10 is of the type including a front member 20 and a back member 30. Front member 20 extends from a proximal in-mouth end 21 to a distal outside end 22 and forms a horizontal passageway 23 between proximal and distal ends 21 and 22. Back member 30 is U-shaped and has a middle portion 31 and a pair of leg portions 32. Middle portion 31 is secured to front-member proximal end 21. Each leg portion 32 extends from middle portion 31 rearwardly for positioning along and between the diver's teeth and terminate at the rear of the diver's mouth. Each leg portion 32 includes a thermoformable custom-moldable bite portion 33.

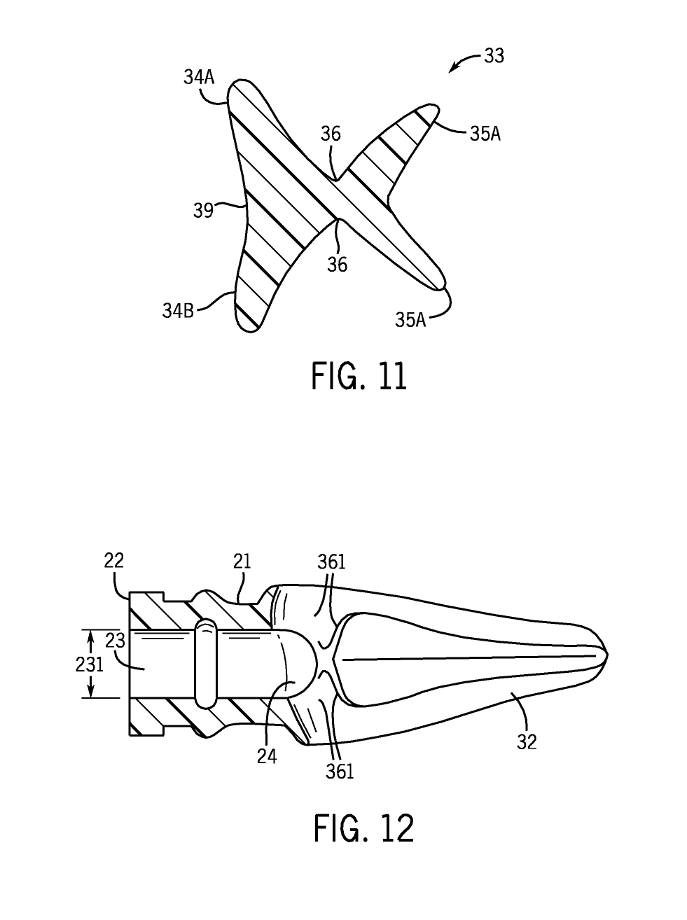

As seen in FIGS. 1-4, each bite portion 33 is formed by an upper-outer wall-portion 34A and a lower-outer wall-portion 34B, and an upper-inner wall-portion 35A and a lower-inner wall-portion 35B. All wall-portions are adjoined at a common bite line 36. Each wall-portion 34 and 35 extends outwardly from bite line 36 such that each leg portion 32 has a substantially X-shaped cross-section across bite line 36, as best seen in FIGS. 2 and 11-13. Bite line 36 may have a minimal horizontal shelf 37 between outer and inner wall-portions 34 and 35. FIG. 11 shows bite portion 33 substantially free of horizontal shelf 37. FIGS. 1-4, 9 and 11-13 best show outer and inner wall-portions 34A with 35A and 34B with 35B forming substantially sharp-angled upper and lower concavities 38A and 38B along bite line 36.

Such configuration with minimal horizontal surfaces and initial positioning of the unmolded side surfaces 361 along bite line 36 in close proximity to the diver's teeth facilitates better side engagement for easier more precise molding of bite portions 33 resulting in better holding of mouthpiece 10 during use. The initial proximity of the unmolded side surfaces 361 to the diver's teeth further decreases lateral expansion of bite surfaces 331 that takes place when the mouthpiece is molded to the diver's teeth.

Upper-outer and lower-outer wall-portions 34 of each leg portion 32 define an outer-surface concavity 39 along bite portion 33 of respective leg portion 32. Concavity 39 further compensates for the lateral expansion of bite surfaces 331.

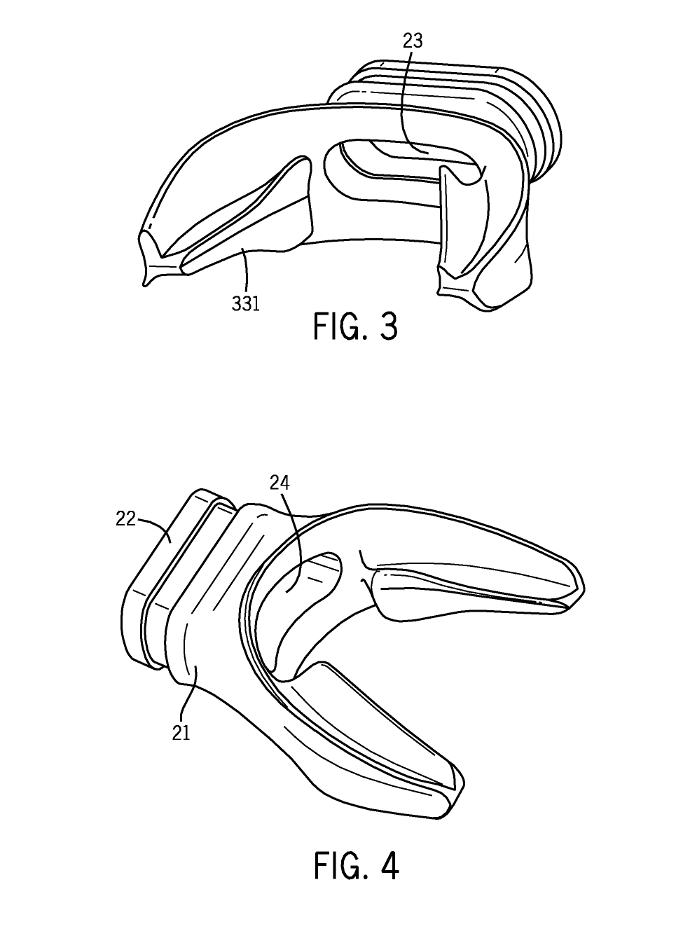

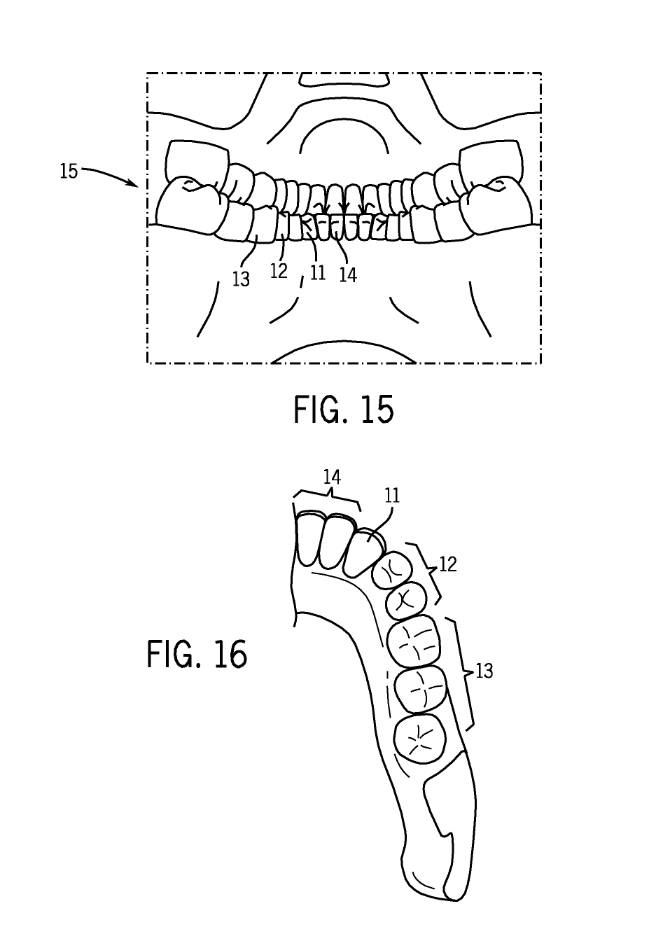

Upper-inner and lower-inner wall-portions 35 of each leg portion 32 each originate laterally to the respective one of the diver's canines 11 (seen in FIGS. 15 and 16). FIGS. 1 and 3 show shortened dimension of inner wall-portions 35 to facilitate reduction of gagging effect because there is less of the inner wall-portions surfaces reacting against lateral surfaces of the diver's tongue. It is shown in FIGS. 1, 3 and 16 that each of upper-inner and lower-inner wall-portions 35 terminates rearwardly beside the diver's premolars 12 and forward of the diver's first molar 13. The more forward termination of inner wall portions 35 also allows lateral air flow which reduces turbulence and improves air passage around closed teeth (seen in FIG. 15) which otherwise block airflow.

FIGS. 1, 3, 4 and 12 best illustrate passageway 23 between proximal and distal ends 21 and 22 of front member 20. Passageway 23 is defined by tapered inner sidewall portions 24 which define the greatest between-sidewall-portions cross-dimension 25 at leg portions 32, whereby facilitating air-flow for the diver's breathing under water. FIG. 12 shows passageway 23 having the widest horizontal cross dimension at proximal in-mouth end 21 adjacent leg portions 32. It is also seen in FIG. 12 that passageway cross-dimension gradually decreases toward the middle of passageway 23. Such in-mouth widening of passageway 23 further facilitates lateral air flow, thereby facilitating air-flow for the diver's breathing under water despite the presence of the teeth which substantially block the air-flow.

Another aspect of the present invention is a method for customizing scuba-diving mouthpiece 10 for gripping with diver's teeth. A bite-limiter 40, shown in FIGS. 1, 2, 6, 8, 13 and 14, is provided in the inventive method. Bite-limiter 40 is of a resilient material that provides soft minimal biting by the diver's incisors 14 while maintaining its integrity in thermoforming temperatures and retaining its shape during the thermoforming process. An example of such material may be a vinyl that becomes moldable at temperatures significantly higher that the boiling temperature of water. Of course, any other suitable material may be used to provide soft texture for comfortable biting. Bite-limiter 40 is positioned between leg portions 32 at proximal end 21 of front member 20 such that diver's incisors 14 engage bite-limiter 40 during molding process to control the degree of bite and depth of tooth impressions. Bite-limiter 40 has upper and lower surfaces 41 which are spaced from one another by a distance corresponding to an appropriate degree of openness of the mouth for scuba diving.

For molding, leg portions 32 are heated until respective bite portions 33 become moldable. The heating is by submerging leg portions 32 in water at near-boiling temperature for a time period sufficient for bite portions 33 to become moldable. The heated unmolded mouthpiece 10 is placed in the mouth of the diver with bite portions 33 positioned between diver's teeth 15. Mouthpiece 10 is molded by the diver biting bite portions 33 until upper and lower incisors 14 engage bite-limiter 40 to make tooth impressions in bite portions 33. Then mouthpiece 10 is removed from the diver's mouth and set with the molded bite portions 33 which have deep impressions of the diver's teeth and gums. Such custom-molded mouthpiece 10 has leg portions 32 that closely conform to diver's teeth 15 and gums for comfortable use and improved breathing under water while diving.

FIGS. 6 and 14 show bite-limiter 40 configured to extend through and beyond front-member passageway 23. The positioning step preferably includes the step of inserting bite-limiter 40 into passageway 23 such that bite-limiter 40 is positioned for engagement with diver's incisors 14.

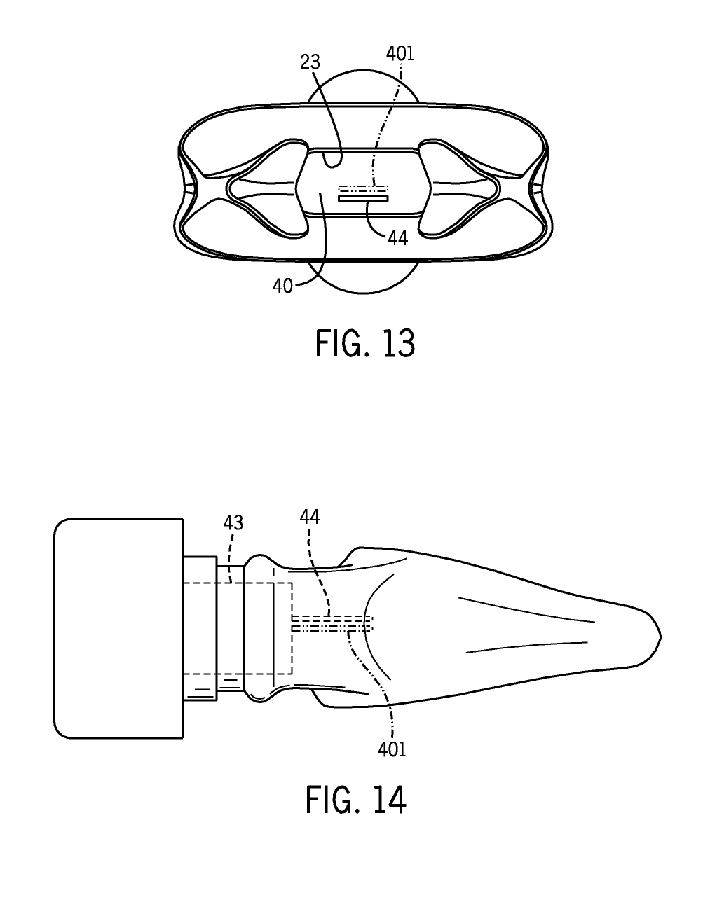

As further seen in FIGS. 1, 6, 8 and 14, bite-limiter 40 includes an exterior handle portion 42 configured for holding by person's fingers to handle mouthpiece 10 during the thermoforming process, an insert portion 43 which extends from handle portion 42 into passageway 23, and a bite-limiting portion 44 which extends from insert portion 43 for positioning between leg portions 32 of mouthpiece 10 for engagement with diver's incisors 14 to control the degree of bite and depth of tooth impressions. FIGS. 2 and 13 show bite-limiting portion 44 having a thickness no greater than one third of a passageway vertical dimension 231 (see FIG. 12). Bite-limiting portion 44 may be no more than three millimeters thick and no less than about one millimeter thick.

FIGS. 13 and 14 show bite-limiting portion 44 vertically offset from the middle 401 of insert portion 43 to accommodate diver's teeth overlap. FIG. 13 shows bite-limiting portion 44 offset below the middle of bite-limiter 40. FIG. 14 shows bite-limiting portion 44 offset above the middle of bite-limiter 40. This is a modification that helps accommodate the molding process for someone who's front teeth overlap a lot or very little. The below or above offsetting of bite-limiting portion is achieved by simple flipping over of bite-limiter 40 such that bite-limiting portion 44 is placed higher or lower relative to the center of the biting area.

Bite-limiting portion 44 is preferably of a resilient material that provides soft minimal biting by the diver's incisors while maintaining its integrity in thermoforming temperatures and retaining its shape during the thermoforming process.

FIG. 1 shows bite-limiter 40 as an integrally-formed single piece which includes exterior handle portion 42 and insert portion 43 with bite-limiting portion 44 secured with respect thereto.

While the principles of the invention have been shown and described in connection with specific embodiments, it is to be understood that such embodiments are by way of example and are not limiting.

1. In a customizable scuba-diving mouthpiece for gripping with a diver's teeth, the mouthpiece including (a) a front member extending from a proximal in-mouth end to a distal outside end and forming a horizontal passageway therebetween, and (b) a U-shaped back member which has (i) a middle portion secured to the front-member proximal end and (ii) a pair of leg portions each extending from the middle portion rearwardly for positioning along and between the diver's teeth and terminating at the rear of the diver's mouth, each leg portion including a thermoformable custom-moldable bite portion, the improvement comprising each bite portion being formed by upper-outer and lower-outer wall-portions and upper-inner and lower-inner wall-portions all adjoined at a common bite line and each extending outwardly therefrom such that each leg portion has a substantially X-shaped cross-section across the bite line.

2. The mouthpiece of claim 1 wherein the bite line is along a minimal horizontal shelf between outer and inner wall-portions.

3. The mouthpiece of claim 2 wherein the bite portion is substantially free of the horizontal shelf.

4. The mouthpiece of claim 2 wherein the corresponding outer and inner wall-portions form substantially sharp-angled upper and lower concavities along the bite line.

5. The mouthpiece of claim 1 wherein the upper-inner and lower-inner wall-portions of each leg portion terminate rearwardly beside the diver's premolars and forward of the diver's first molar, whereby reducing gagging effect.

6. The mouthpiece of claim 1 wherein the passageway is defined by tapered inner sidewall portions defining the greatest between-sidewall-portions cross-dimension at the leg portions, whereby facilitating air-flow for the diver's breathing under water.

7. The mouthpiece of claim 6 wherein the upper-inner and lower-inner wall-portions of each leg portion terminate rearwardly beside the diver's premolars and forward of the diver's first molar, whereby reducing gagging effect.

8. In a customizable scuba-diving mouthpiece for gripping with a diver's teeth, the mouthpiece including (a) a front member extending from a proximal in-mouth end to a distal outside end and forming a horizontal passageway therebetween, and (b) a U-shaped back member which has (i) a middle portion secured to the front member proximal end and (ii) a pair of leg portions each extending from the middle portion rearwardly for positioning along and between the diver's teeth and terminating at the rear of the diver's mouth, each leg portion including a thermoformable custom-moldable bite portion, the improvement comprising the upper-inner and lower-inner wall-portions of each leg portion terminating rearwardly beside the diver's premolars and forward of the diver's first molar, thereby reducing gagging effect.

9. In a customizable scuba-diving mouthpiece for gripping with a diver's teeth, the mouthpiece including (a) a front member extending from a proximal in-mouth end to a distal outside end and forming a horizontal passageway therebetween, and (b) a U-shaped back member which has (i) a middle portion secured to the front member proximal end and (ii) a pair of leg portions each extending from the middle portion rearwardly for positioning along and between the diver's teeth and terminating at the rear of the diver's mouth, each leg portion including a thermoformable custom-moldable bite portion, the improvement comprising the passageway being defined by tapered inner sidewall portions defining the greatest between-sidewall-portions cross-dimension at the leg portions, thereby facilitating air-flow for the diver's breathing under water despite the presence of the teeth which substantially block the air-flow.

10. In a customizable scuba-diving mouthpiece for gripping with a diver's teeth, the mouthpiece including (a) a front member extending from a proximal in-mouth end to a distal outside end and forming a horizontal passageway therebetween, and (b) a U-shaped back member which has (i) a middle portion secured to the front member proximal end and (ii) a pair of leg portions each extending from the middle portion rearwardly for positioning along and between the diver's teeth and terminating at the rear of the diver's mouth, each leg portion including a thermoformable custom-moldable bite portion, the improvement comprising a bite-limiter including:
an exterior handle portion configured for holding by person's fingers for handling the mouthpiece during the thermoforming process;
an insert portion extending from the handle portion for positioning within the passageway; and
a bite-limiting portion extending from the insert portion for positioning between the leg portions of the mouthpiece for engagement with the diver's incisors to control the degree of bite and depth of tooth impressions, the bite-limiting portion having a thickness no greater than one third of a passageway vertical dimension.

11. The mouthpiece of claim 10 wherein the bite-limiting portion is no more than three millimeters thick.

12. The mouthpiece of claim 11 wherein the bite-limiting portion is no less than one millimeter thick.

13. The mouthpiece of claim 10 wherein the bite-limiting portion is of a resilient material that provides soft minimal biting by the diver's incisors while maintaining its integrity in thermoforming temperatures and retaining its shape during the thermoforming process.

14. The mouthpiece of claim 13 wherein the bite-limiter has an integrally-formed single piece including the exterior handle portion and the insert portion with the bite-limiting portion secured with respect thereto.

15. The mouthpiece of claim 10 wherein the bite-limiting portion is vertically offset from the middle of the insert portion to accommodate diver's teeth overlap.

16. A method for customizing a scuba-diving mouthpiece for gripping with a diver's teeth, the mouthpiece including (a) a front member extending from a proximal in-mouth end to a distal outside end and forming a horizontal passageway therebetween, and (b) a U-shaped back member which has (i) a middle portion secured to the front member proximal end and (ii) a pair of leg portions each extending from the middle portion rearwardly for positioning along and between the diver's teeth and terminating at the rear of the diver's mouth, each leg portion including a thermoformable custom-moldable bite portion, comprising:
providing a bite-limiter of a resilient material that provides soft minimal biting by the diver's incisors while maintaining its integrity in thermoforming temperatures and retaining its shape during the thermoforming process;
positioning the bite-limiter between the leg portions at the proximal end of the front member for engagement with the diver's incisors to control the degree of bite and depth of tooth impressions;
heating the leg portions until the respective bite portions become moldable;
placing the heated unmolded mouthpiece in the mouth of the diver with the bite portions positioned between the diver's teeth;
biting the bite portions until the upper and lower incisors engage the bite-limiter to make tooth impressions in the bite portions;
removing the mouthpiece from the diver's mouth; and
setting the mouthpiece with the molded bite portions.

17. The method of claim 16 wherein the bite-limiter is configured to extend through and beyond the front-member passageway and the positioning step includes the step of inserting the bite-limiter into the passageway such that the bite-limiter is positioned for engagement with the diver's incisors.

18. The method of claim 16 wherein each bite portion being formed by upper-outer and lower-outer wall-portions and upper-inner and lower-inner wall-portions all adjoined at a common bite line and each extending outwardly therefrom such that each leg portion is substantially X-shaped in cross-section across the bite-line.

19. The method of claim 16 wherein the upper-inner and lower-inner wall-portions of each leg portion terminate rearwardly beside the diver's premolars and forward of the diver's first molar, whereby reducing gagging effect.

20. The method of claim 16 wherein the passageway is defined by tapered inner sidewall portions defining the greatest between-sidewall-portions cross-dimension at the leg portions, whereby facilitating air-flow for the diver's breathing under water.

21. The method of claim 16 wherein the bite-limiter includes:
an exterior handle portion configured for holding by person's fingers to handle the mouthpiece during the placing and removing steps;
an insert portion extending from the handle portion for insertion into the passageway during the positioning step; and
a bite-limiting portion extending from the insert portion for positioning between the leg portions of the mouthpiece for engagement with the diver's incisors to control the degree of bite and depth of tooth impressions, the bite-limiting portion having a thickness no greater than one third of a passageway vertical dimension.
